(19) United States
(12) Patent Application Publication
(10) Pub. No.: US 2008/0235107 A1
(43) Pub. Date: Sep. 25, 2008

(54) Method and apparatus to search the web with dynamic guiding information and guide selections

(75) Inventor: Nagendra Nagarajayya, Pleasanton, CA (US)

Correspondence Address: TRANSAXTIONS LLC;Nagendra Nagarajayya, 4302 Denker Dr, Pleasanton, CA, 94588, US

(73) Assignee: TRANSAXTIONS LLC, Pleasanton, CA (US)

(21) Appl. No.: 12/053,555

(22) Filed: Mar. 22, 2008

Related U.S. Application Data
(60) Provisional application No. 60/896,515, filed on Mar. 23, 2007.

(51) Int. Cl. G06Q 30/00

(52) U.S. Cl. 705/26

(57) ABSTRACT

A method and apparatus for searching a need on the internet or intranet allowing results to be dynamically updated using a backend process; the said results could include guiding information with guide selections allowing a user to make a knowledgeable buy at a reasonable price.

### FIELD OF THE INVENTION

The present invention describes a method and an apparatus for searching on the intranet or internet. The results of search are shown with dynamic guiding information and guide selections allowing the user to find products, market information, competitive and comparative information and also buy in multiple ways.

### BACKGROUND OF THE INVENTION

Buying online is just at its infancy and has no geographical borders and barriers. A person in the US to a person in Singapore, China or India could be buying online from the same merchant at the same time. Comscore [O-1] the well known market research firm said that cumulative online buying reached $ 10.2 billion between November 1 to December 15, with the peak on December 12 reaching sales of $218 million for non travel related items. This is an increase of 32% over 2001. So 2005 should see at the same growth, about $23 billion in online sales—non travel related sales. This is just during the holiday season. Online sales for 2004 exceeded $117 billion with sales for non-travel related increasing to $66.5 billion, an increase of 26% over 2003.

Internet auctions are also popular and allow a buyer to bid on a product online. A buyer might pay a lot more when similar products are available in stores. Prof. Richard Freeman, co-director of the “Centre for Economic Performance at the London School of Economics” and Harvard professor, is looking at user behavior at internet auctions. He warns that users get excited and often bid too high called the winner's curse. In Christmas 2000, Sony Playstations were being sold at inflated prices at internet auctions while High Street stores were selling it at reasonable prices. Cautionary tales abound of hapless shoppers unable to control their obsession and caught in bidding wars for items that they did not want. In a New York Times piece, Michelle Slatalla confesses of buying an item for $2300 when she set out to buy a used system for $800. Reverse auctions on the other hand allow the buyer to set a price and bidding to be initiated by the sellers. But a buyer not knowing the market information can set too high a price for a product and buy at above market prices. A Buyer in an auction might not be very knowledgeable about an item, or if the item is a popular item, or the market information for the item like the low price or average price for a region. They have to do their own research and end up buying items that they might not need or paying a high price for it instead of a reasonable price. Reverse Auctions also introduce deterioration in buyer/seller relationship due to falling prices.

According to Comscore users typically start their buying process at the search engines with generic terms like “lcd tv” to become knowledgeable. They then proceed offline to a store, etc. to get information about the product, followed by a latent search session or proceed directly to their favorite retailer to buy the product. The latent search session is still generic terms such as “lcd tv” and only a few percentage move to product specific terms such as “Panasonic or Sony LCD TV TC-32LX60”. Comparative search is another favorite way users search, compare and become knowledgeable about products and prices. Hidden web searches, wherein content is not available in a static or dynamic html pages but might need to be queried through special or custom forms or search criteria and in real-time to retrieve information like air fares, hotel room prices, real estate, dating services, product information, event tickets, etc., are very popular and allow the user to retrieve and compare information and buy. Users searching for generic terms like “lcd tv” or “laptop computer” or “mortgage loan” and sometime specific terms such as “Taco Bell” or “Panasonic TV” and expect to get information related to finding the restaurant “Taco Bell”, or buying a “Panasonic TV” or a “Laptop computer” or information about a “mortgage loan”. A user searching for “Panasonic TV” expects to see the popular models, models on sale, market competitive information, information about TVs, LCD TVs, etc. A user searching for a “Laptop computer” is interested in knowing more about a laptop computer, a computer, different models on sale, popular selections, market information, etc. For a “mortgage loan” or “need a mortgage loan” the user might be interested in, what is a mortgage loan?, types of loan products, current interest rates, different mortgage brokers, bankers, market competitive information, etc. A user searching for “relief from cough” or “tantrums 10 yr old” is looking to find information related to relief from a cough or how to overcome the tantrums thrown by the 10 yr old. The search engines with natural language ability do try to understand the context but again might not present the information needed by the user.

Web 2.0 makes it possible to update information selectively on a client browser from a server and provide a rich experience to a user. A search engine with dynamic guiding information and guide selections that can update a client in real-time using web 2.0 as information becomes available on the intranet or internet can solve the problems associated and described above. A search engine associated with a marketplace provides further advantages like being able to buy immediately or posting a need to a competitive process. The primary purpose of the present invention is to solve the problems described above and to provide further, related advantages.

### BRIEF DESCRIPTION OF THE INVENTION

Every presence has needs or economic wants. A need could be consumer electronics, loans, autos, tickets, shelter, etc. The presence uses the invention to search for the need on the intranet or internet. The results of the search with guiding information and guide selections are dynamically updated on the client using a backend process, enabling the presence to see the most relevant results, become knowledgeable and maybe spend a monetary amount to satisfy the need.

### BRIEF DESCRIPTION OF THE DRAWINGS

The accompanying drawings, which are incorporated into and constitute a part of this specification, illustrate one or more embodiments of the present invention and, together with detailed description, serve to explain the principles and implementations of the invention.

FIG. 1 is an illustration of ENeedsOnline marketplace.

FIG. 2 is an illustration of a user click on a “Cheap Air Fares” and illustrates a form used to enter the search criteria.

FIG. 3 is an illustration of a user click on the “Search button” and illustrates a page with multiple zones that are refreshed dynamically.

FIG. 4, 4-1, 4-2, 4-3, 4-31, 4-32 is an illustration of dynamic guide selections and the results being refreshed dynamically at various zones

FIG. 5, FIG. 5-1 is an illustration of a user being transferred to a booking site.

FIG. 6 is an illustration of a user click to see results from a specific site.

FIG. 7 is a flow chart of what happens when the “search” button is clicked as in FIG. 2.

FIG. 8, 8-1, 8-2 are flow charts of what happens when the web container passes on the search criteria to the backend server.

FIG. 9 is a flow chart of what happens at the client browser as the results start coming back from the web container.

FIG. 10 is an illustration of multiple ways to buy.

### REFERENCES CITED

### U.S. Published Applications

| | | | |
|---|---|---|---|
| 20070226189 | Aug. 31, 2006 | John William; et al | 707/3 |
| 20070288314 | May 25, 2007 | Cao; Yu; et al | 705/14 |
| 20060277167 | May 19, 2006 | Gross; William; et al | 707/3 |

### Other References

O-1 Comscore Research Report, “Consumers Again Break Online Spending Record, Reaching $2.2 Billion, Reports Comscore”, Dec. 17, 2002, http://www.comscore.com/press/release.asp?id=286

O-2 Comscore Research Report, “Vast Majority of Search-influenced Buying Occurs Either Offline or in Subsequent Internet User Sessions”, Dec. 13, 2004, http://prnewswire.com/cgi-bin/stories.pl?ACCT=104&STORY=/www/story/12-13-2004/0002627947&EDATE=
O-3 Comscore Research Report, “In An Age Of Unprecedented Consumer Expectations, Retailers Must Eliminate Remaining Barriers Between Shopping Channels”, Jan. 19, 2005, http://www.comscore.com/press/release.asp?press=549
O-4 need description in the wikipedia, http://en.wikipedia.org/wiki/Need, http://en.wikipedia.org/wiki/Fundamental_human_needs#_note-1
O-5 Economic want, http://en.wikipedia.org/wiki/Wants
O-6 Competitive market, http://en.wikipedia.org/wiki/Perfect_competition, http://en.wikipedia.org/wiki/Supply_and_demand
O-7 Differences between Need and Want, http://www.montgomeryschoolsmd.org/curriiculum/socialstd/MSPAP/Clarification_K3.html, http://:/www.learningtogive.org/papers/index asp?bpid=19

### PARENTS CASE TEXT

### Cross-Reference to Related Applications

This application claims priority of US provisional application, number US60/896,515, titled “Web Search with Guiding Information and Guide Selections” filed Mar. 23, 2007 by the present applicant.

This application references U.S. patent application Ser. No. 11/161,897, titled “Obtaining A Need With Guiding Information And Credit Worthiness Using A Competitive Process” filed Aug. 22, 2005 by the present applicant.

This application references U.S. patent application Ser. No. 11/308,093, titled “Guiding Info Tabs With Guide Selections” filed Mar. 6, 2006 by the present applicant.

This application refers to the U.S. patent application Ser. No. 11/532,539 titled “Marketplace, an easy way to manage your e-needs” filed Sep. 18, 2006 by the present applicant.

### DETAILED DESCRIPTION OF PREFERRED EMBODIMENTS

Embodiments of the present invention are described herein in the context of a method and apparatus for emulating a competitive process. Those of ordinary skill in the art will realize that the following detailed description of the present invention is illustrative only and is not intended to be in any way limiting. Other embodiments of the present invention will readily suggest themselves to such skilled persons having the benefit of the disclosure. Reference will now be made in detail to the implementations of the present invention as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business related constraints, and that these specific goals will vary from one implementation to another and from one developer to another. Moreover, it will be appreciated that such a development effort might be complex and time consuming, but would nevertheless be routine undertaking of engineering for those of ordinary skill in the art having the benefit of this disclosure.

In accordance with the present invention, the components, process steps, and/or data structures may be implemented using various types of operating systems, computing platforms, computer programs, and or/general purpose machines. In addition, those of ordinary skill in the art will recognize that devices of a less general purpose nature such as hardwired devices, field programmable gate arrays (FPGAs), application specific integrated circuits (ASICs), or the like, may also be used without departing from the scope and spirit of the inventive concepts disclosed herein.

The purpose and idea of the invention is to provide a search engine with dynamic guiding information and guide selections. The search engine can be associated with a marketplace, allowing a presence to become knowledgeable about a need, and be able to buy the need in multiple ways. Guiding information patent pending application U.S. Ser. No. 11/161,897 allows a buyer a buy a need from a plurality of sellers using a competitive process [O-6]. Guide Selections patent pending application U.S. Ser. No. 11/308,093 allows information to be color coded so that a user can associate input to information. The information can be a selection of products coded with tabs in different color. Marketplace, an easy way to manage your eneeds, patent pending application U.S. Ser. No. 11/532,539 provides a buyer multiple views to become knowledgeable about a product, and also buy in multiple ways.

A presence is an entity such as a user using the internet to search for a need. A need as defined in wikipedia [O-4][O-5][O-7] or in economics is a necessity or something that a presence or person requires for existence and successful living in a society. Economics separates a need into essential requirements for existence and comforts. The comforts are called wants. The need in the invention refers mostly to Economic wants but could apply to essential necessities. Economy want is the need to buy an airline ticket, the need to buy a consumer item like a TV or the need to search for information to increase ones knowledge or the need to take a vacation to relax or the need to watch an event or the need to buy real estate to shelter self, etc. Dynamic comes from the use of web 2.0 allowing a client browser window to be refreshed selectively from the server side. Web 2.0 is the use of XMLHttpRequest to make calls from the client browser to the server, refreshing selective areas on the client browser window avoiding whole page refresh. XMLHttpRequest can be initiated with a timer or user interaction.

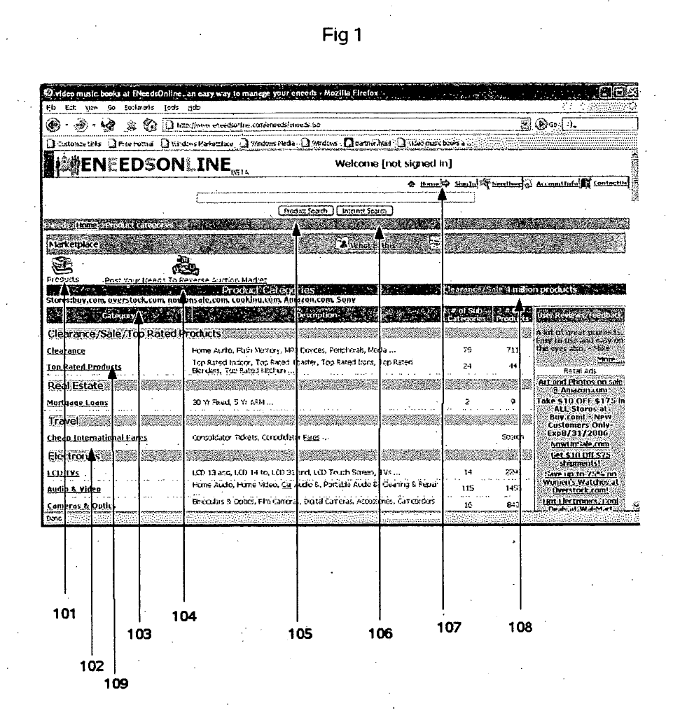

FIG. 1 is an illustration of ENeedsOnline.com home page. The figure illustrates a marketplace made up of a search engine, products, comparison shopping, reverse auction, stores, etc. 101 is the Product View and shows products available in the marketplace. A user can buy a product in multiple ways by searching, comparing, posting the need to the reverse auction marketplace, using the “Buy Now” link to buy immediately or Buy using the store view. 102 shows a category, the category when clicked on opens a search mechanism, 109 shows a category with sub categories and products. 103 is a list of stores that can be accessed from a Store View. 104 is the link to “Post A Need To The Reverse Auction Market Place”, a user can post a need to a reverse auction marketplace for competitive bidding. 105 is the product search button for searching within the marketplace, 106 is the internet search button for searching on the internet, 107 is the sign-on mechanism, 108 shows the number of the products in the market place.

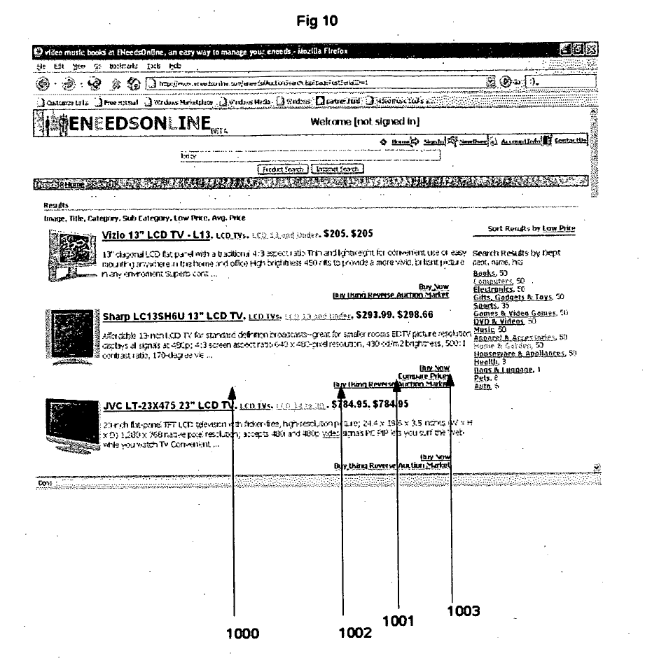

According to Comscore [O-2], a user looking for a product usually starts with a search at the search engines and then goes offline and usually follows up with a return search session to get more information, compare prices and either buys it online or goes offline to buy. The marketplace is designed to build on this and provides an intelligent search engine that can be used to search within the marketplace or on the internet. The search results could be associated with guiding information and guide selection, U.S. patent application Ser. No. 11/308,093, enabling the user to become knowledgeable about a need and buy immediately instead of continuing with the search. A user instead of using 106 might start with 105 to search for products. 105 is a search within the marketplace and allows the user to get guiding information with guide selections, buy immediately, compare prices or post a need for a product to the competitive marketplace. Users usually like to compare prices before buying. They also like guiding information and guide selections to become knowledgeable about a product. FIG. 10 is an illustration of search results after a search within the marketplace. 1000 is the search results, 1001 is a “Compare Prices” link and allows a user to compare prices and buy from the lowest priced store. 1002 is a “Buy Using Reverse Auction” link and allows a user to post the need for a product to the competitive market place, U.S. patent application Ser. No. 11/161,897. The 1003 “Buy Now” link allows the user to buy immediately from a store. Another research from Comscore shows that users like to buy directly from their favorite stores [O-3]. The Store view 103 allows a user to buy from their favorite store.

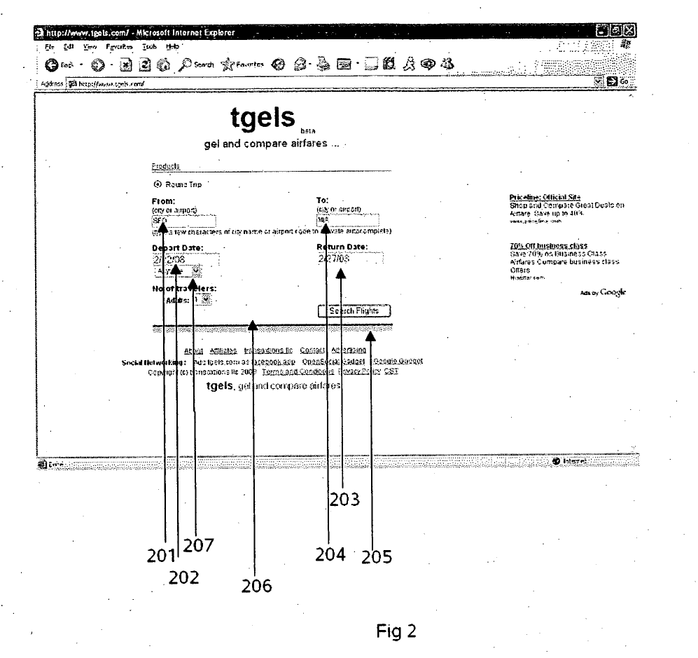

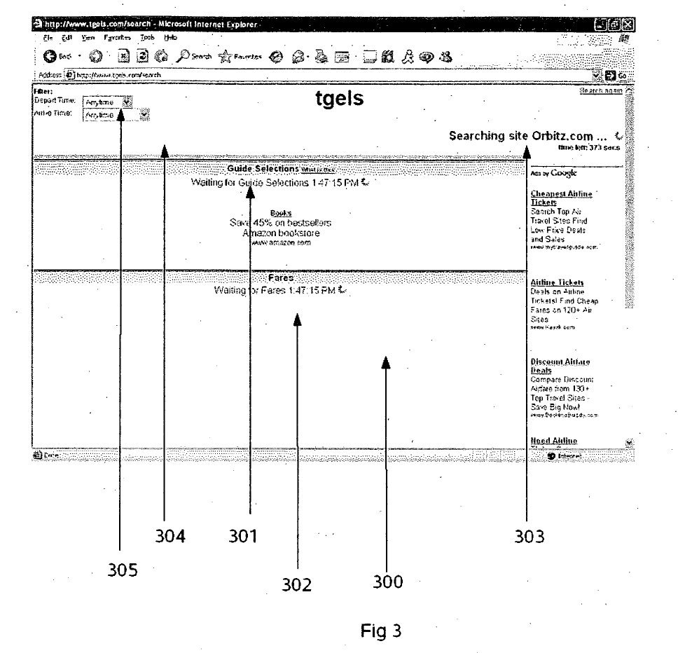

FIG. 2 is an illustration of a user click on the category 102 “Cheap Air Fares”. This takes the user to a search mechanism that can be used to query for more information, compare prices maybe with guiding information and guide selections, buy now options, etc. 206 is a query form for retrieving airfares. 201 is the “From” field, 204 is the “To” field, 202 is the “Depart date” and 203 is the “Return date”, 207 is a filter “Depart time”, 205 is the “Search button”. Clicking on 205 takes the user to FIG. 3 with the dynamic guiding information with guide selections, along with the other results and multiple ways to buy options. A form to search for airfares is shown in this embodiment but similar search forms or a simpler query input could be available to search for needs like event tickets, real estate, consumer products, etc.

FIG. 3 is an illustration of what happens after a user click on the “Search button”. 300 shows the different zones on a web page, 303 is a dynamic update of sites being searched. 301 is the dynamic guiding information zone waiting to display guiding information with guide selections. 302 is the dynamic fare zone waiting for results to be returned from the server. 304 is the dynamic guide selections table zone not visible waiting to update booking site information. 305 is the filter menus that allow results to be filtered on criteria. The dynamic content of a zone is shown through a clock changing every second. Only a zone or a portion of a page is updated using Web 2.0. This particular embodiment uses AjaxAnywhere to update a zone. An AjaxAnywhere Zone is a target area on a web page and is marked by <aa:zone>, </aa:zone> tags. The zones can be refreshed with a user action such as clicking on a link or pressing the submit button or a timer setup to refresh the zone. On a user action or clock cycle, AjaxAnywhere technology makes a XMLHttpRequest to the server. The server receives the request and verifies that it is a AjaxAnywhere request and executes an action, and sets up the zones to be refreshed. The server output is refreshed to the specified zone areas on the browser. AjaxAnywhere uses the <div> tag as a container to achieve this. In this embodiment, AjaxAnywhere technology has been used but in another embodiment, other Web 2.0 technologies could be used to communicate between the client and the server.

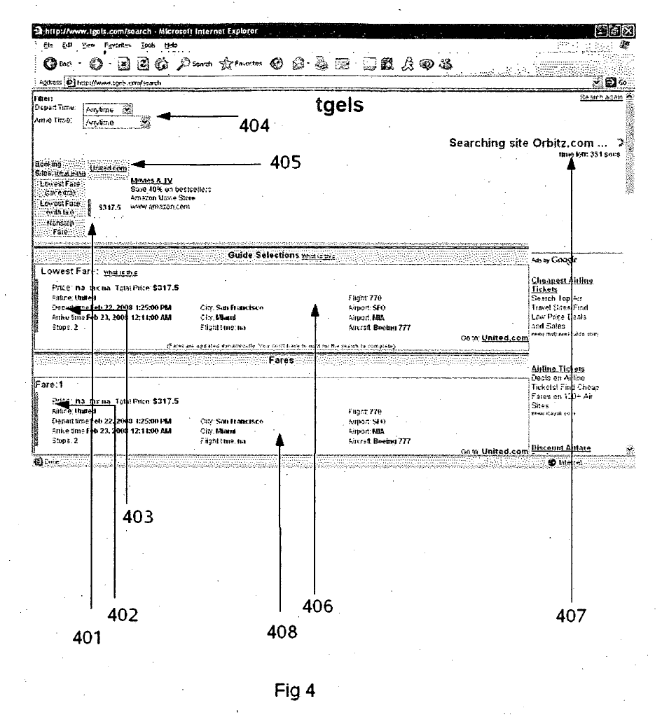

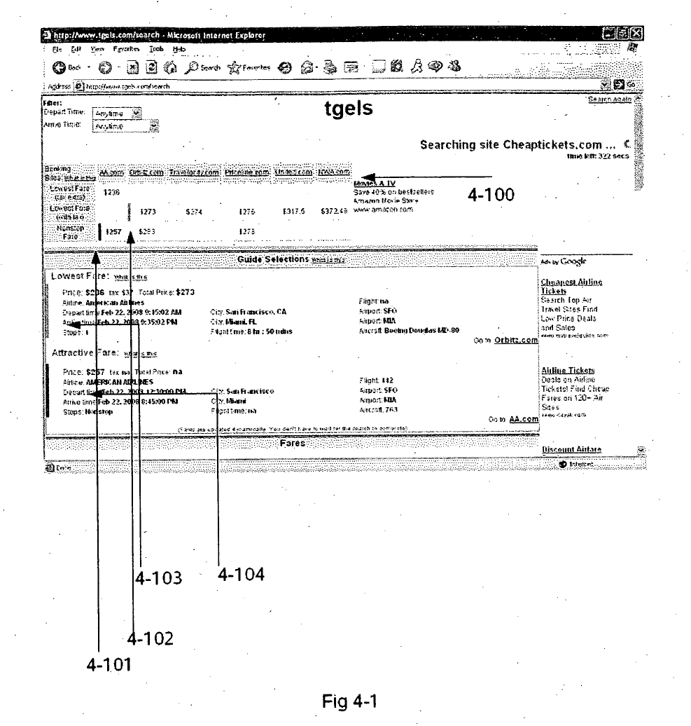

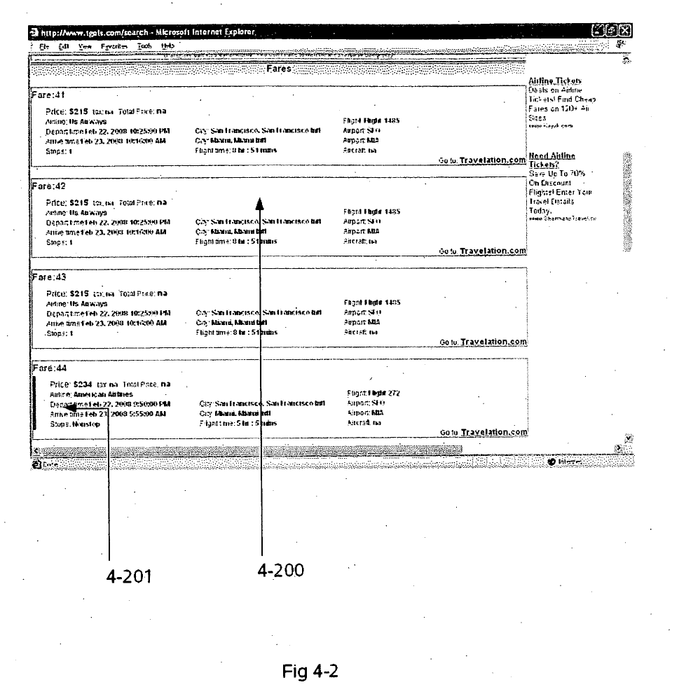

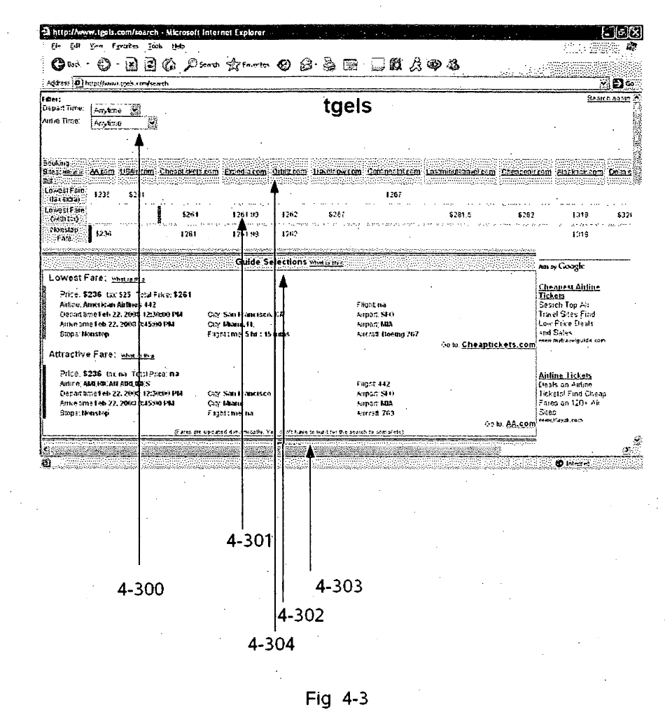

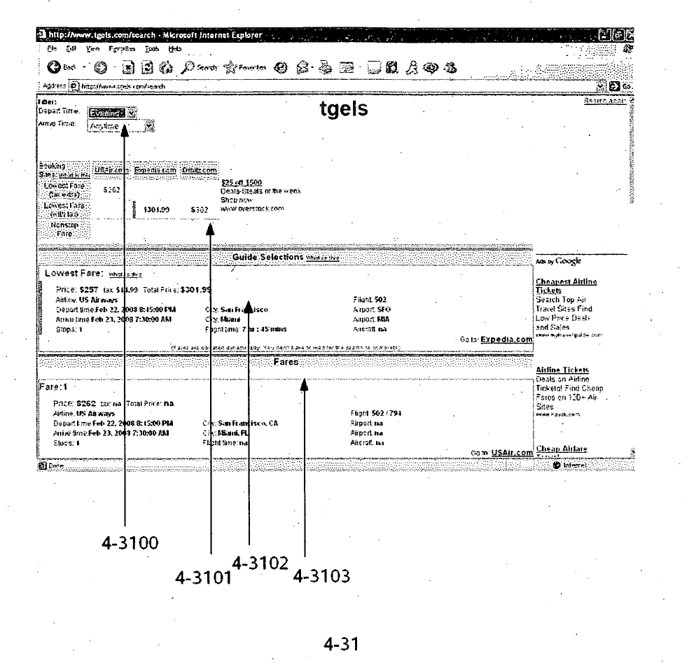

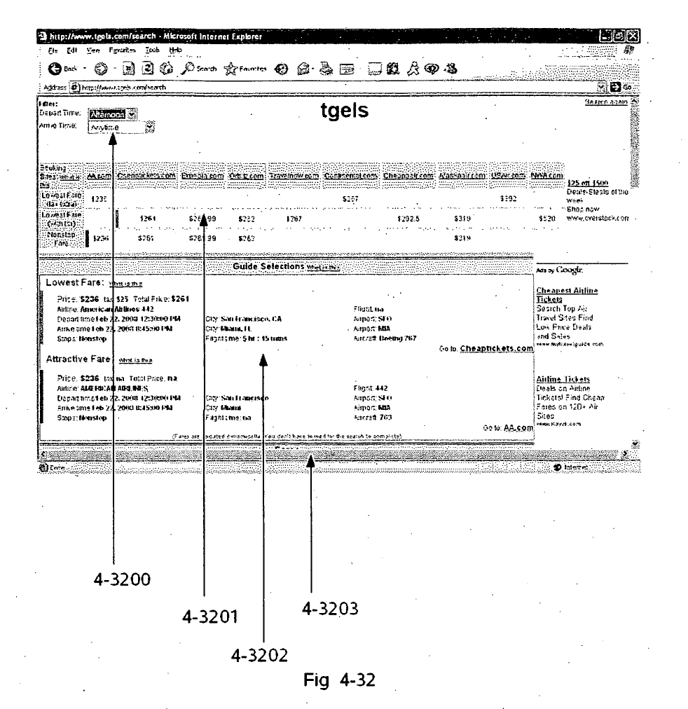

FIG. 4 is an illustration of the dynamic portions changing with time as results are returned back from the search. As guiding information and guide selections become available 406 keeps getting updated. 406 is the same as 301 but with guiding information and guide selections. A user could see guide selections like lowest fare, attractive fare, smart fare, prudent fare or the most popular air fare, etc. 405 shows booking sites that have been searched. 405 is the same as 304 but with booking site results. The results have been tabulated as Lowest fare (tax extra), Lowest fare (with tax) and NonStop fares. The table is updated dynamically resulting in the table growing with each update. This keeps the user glued to the screen and also jumping as the guide selection tabs are updated onto the table. Guide selection tab 401 shows the lowest fare. The tab keeps changing positions as booking site fares become available and is updated onto the dynamic guide selections table. 404 shows the filter options. 407 shows booking sites being searched, 407 also shows the time left for the search. In this embodiment, time is being decremented to provide the user a time indicator of the search. In another embodiment, time could be incremented or a percentage shown. 403 shows the Lowest fare guide selection with guiding information. In this embodiment the Lowest fare is visible but in other embodiments more guide selections or other selections could be shown. 405 shows booking sites so that a user can click on a site and shop from their favorite site, see U.S. patent application Ser. No. 11/532,539, for more information about users visiting their favorite stores as in 103. 405 also shows Lowest Fares (tax extra), Lowest Fare (with tax) and NonStop Fares in this embodiment but could be tabulated in a different way in other embodiments. 408 is the fare zone. 402 shows the Lowest fare in the fare zone allowing the user to match a guide selection tab with a fare. FIG. 4-1 is an illustration showing the dynamic guide selections table growth. 4-100 is the same as 405 and 304 but with more booking sites and shows the table growth. 4-101 show a new guide selection tab Attractive Fare. 4-102 is the same as 401, the Lowest Fare guide selection but now updated to reflect a new Lowest Fare. 4-103, 4-104 show the new Lowest Fare and Attractive Fare guide selections with guiding information. FIG. 4-2 is a more detailed illustration of the fare zone. 4-200 shows fares returned from the backend server and 4-201 shows the Attractive fare. The fares are updated dynamically as they become available. The guide selections, dynamic guide selections table and fares keep changing in real-time as the zones are updated dynamically as fares become available. In this embodiment only a few zones are shown but in another embodiment more zones could be shown and the invention should not be limited to as shown in the embodiment. FIG. 4-3 is an illustration of the results showing the filter options “Depart time” and “Arrive time” set at “Anytime”. 4-300 shows the filter options set at Anytime, 4-301 is the Dynamic Guide Selections Table with Fares from Booking Sites, 4-302 is the Guide Selection showing Lowest and Attractive Prices, 4-303 is the Fares returned back from the server (partially visible). FIG. 4-31 is an illustration of the results when the filter “Depart time” is changed to “Evening”. 4-3100 shows the filter options with “Depart time” set to “Evening”, “Arrive Time” is still at “Anytime”, 4-3101 is the Dynamic Guide Selections Table showing Booking Sites that match the filter criteria, 4-3102 shows the new Guide Selections, 4-3103 shows Fares matching the criteria. FIG. 4-32 is an illustration of the results when the filter “Depart time” is changed to “Afternoon”, 4-3200 shows the filter options, 4-3201 shows the new Dynamic Guide Selections Table, 4-3202 shows the Guide Selections and 4-3203 shows the new Fares (partially visible). In this embodiment only time options are shown but in other embodiments, filter options like NonStop Flights, Booking Site, Airlines, etc. maybe available. Other options like sorting by Airlines, Travel time, Depart, Arrival Times, Fares; fare consolidation by Airlines, time or by price, etc. may also be available in other embodiments.

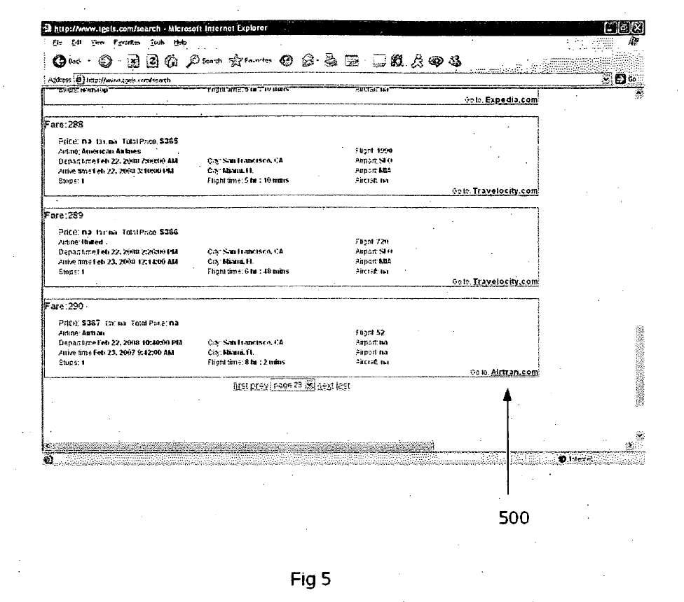

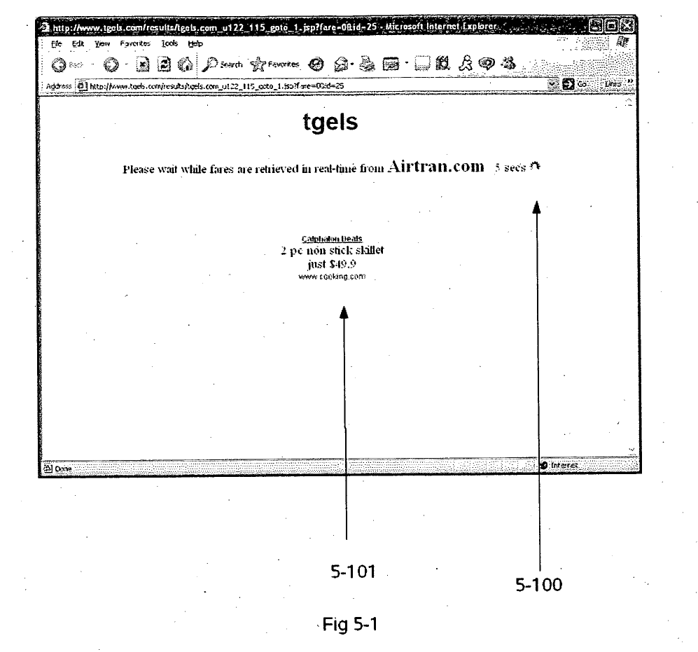

FIG. 5 is an illustration of a user clicking on a “Booking Site” link. Clicking on 500 transfers the user to the Booking site selling that particular fare so that the user can purchase it directly from the site. A Click as in 500 is a click on the hyperlink javascript:launchParms(‘/results/tgels.com_u0_{—}118_goto_{—}0.jsp’, . . . ). The javascript opens a new window with the link to be refreshed from the server. The server receives the request to load the .jsp file. The .jsp file contains multiple Ajaxanwhere zones like a timer, a form, Ad zone, etc. The timer zone keeps track of the elapsed time in seconds. The form zone at the end of the elapsed time, sends back the HTML form elements needed to submit a search request to a booking site. The Ad zone could be used to show Ads or something relevant to the user. On the client, Ajaxanywhere makes a XmlHttpRequest to the backend server every second and refreshes only the requested zone area with new content. The backend server refreshes the time zone for about 10 secs and then refreshes the form zone containing the HTML elements needed to transfers control to the booking site. At the next refresh instead of sending the request to the backend server, the form is submitted to the booking site so that search results from the booking site become available to the client. In this embodiment a search form is submitted to the booking site, but in another embodiment, the user could be transferred directly to a fare so that the user could book that particular fare or be transferred just to the booking site where the user might need to search again. In this embodiment only a few zones or shown but in another embodiment, there could be more or less zones. Also, a link with a specified file form is shown but in other embodiments this could be done differently. In this embodiment, transferring the user to a site is shown, but other forms of buying like transferring the user to a competitive process could be shown so that the user could post the need to the marketplace for competitive bidding. The embodiment shows air fares but in another embodiment this could be event tickets or consumer products, real estate, etc. FIG. 5-1 is an illustration of the user waiting to be transferred to the Booking site. The transfer is again implemented as a dynamic zone so that a timer tick can be shown 5-100. The page also shows other relevant information or an Ad 5-101 before the user gets transferred to the site.

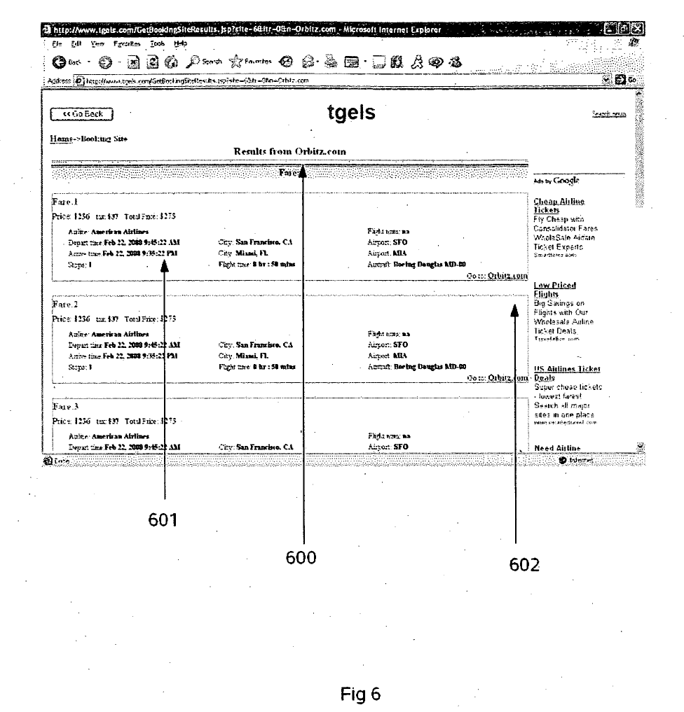

FIG. 6 is an illustration of a user click on 4-304 taking the user to results from a specific site—see Comscore research O-3 that users like to buy directly from their favorite store—so that users who like to buy directly from their favorite stores can see the results from their favorite booking site and buy from there. 600 is the site, 601 are the results from the site, 602 allows the user to buy from the booking site. A click on 602 transfers the user to the booking site as in a click on 500.

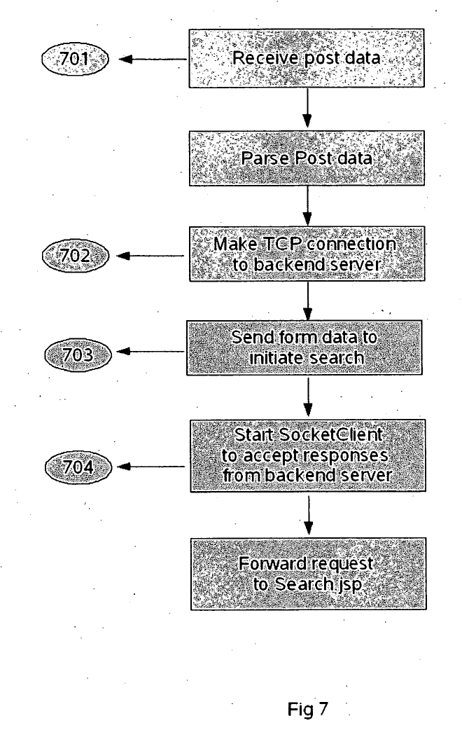

Clicking on 205 submits the user input to a backend system which receives the input, processes the different parameters and then makes a connection to another backend server to retrieve the results from different internet or intranet based data sources and maybe in real-time. The data sources could be running http servers, database servers, web services, etc. and could be serving html, xml or other forms of data. FIG. 7 shows the backend system receiving input from 205. 701 receives the post data. 702 makes a connection to a TCP server. 703 sends the form data to initiate the searches. 704 starts a SocketClient thread to wait for responses from the server and forwards the request to the Search.jsp web page. In this embodiment the request is forwarded to another backend server but in other embodiments, it could be processed on the same server.

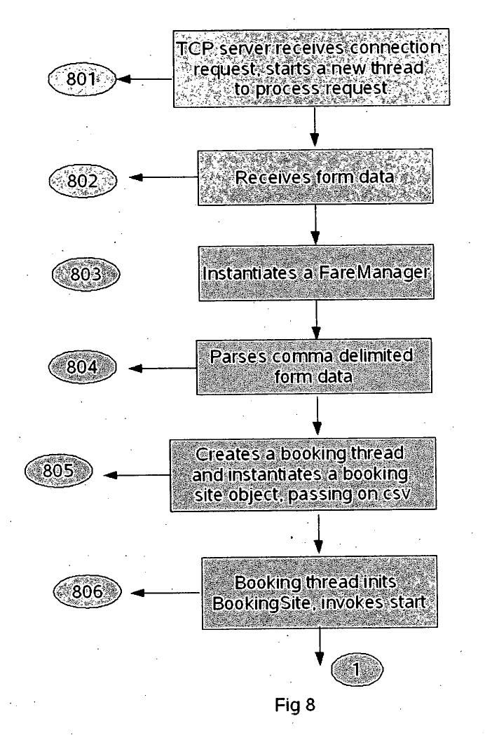

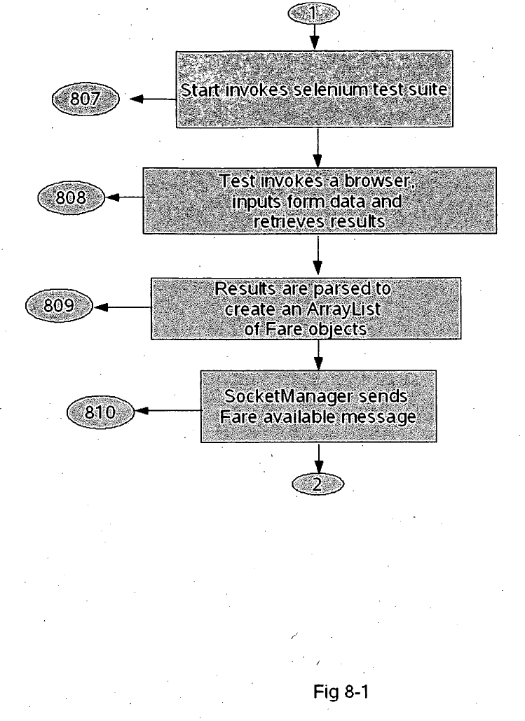

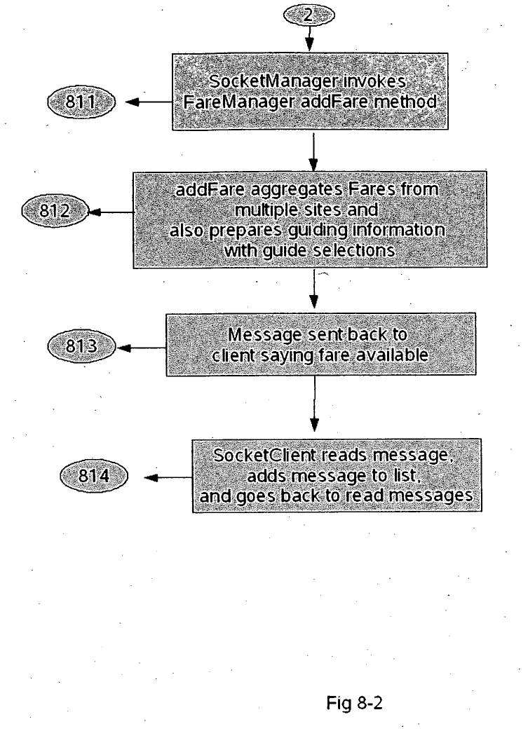

FIG. 8 shows the TCP server which receives the connection request 801, starts a new thread to process the connection 802. 803 instantiates a FareManager object, 804 parses the form data which is comma delimited and creates a Booking thread for each site to be searched, instantiates a BookingSite object and passes on the comma separated form data to each site as the search criteria 805. The booking thread initializes the booking site object and invokes the start method 806. The start method executes a selenium test suite 807 in this embodiment but in other embodiments a browser with scripting or an api, etc. could be used. The test invokes a browser window which invokes the site URL, fills up any search forms and submits the form to retrieve the results 808. The returned results are validated and the html is captured on a shared file system. The html file is parsed by an automatic parser to create a list of Fare objects 809. Each Fare objects holds departing city, airport, arriving city, airport, times, and other related information including price, tax, etc. The Fare object also provides methods to retrieve these and also the URL or script to invoke a fare. Once the list of Fare objects are created, the Socket Manager is used to send a message that a Fare is available 810. The Socket Manager invokes the Fare Manager's addFare method to add the list of Fares 811. The addFare aggregates fares retrieved from multiple sources and also prepares the guiding information and guide selections to be sent back to the client 812. The aggregated Fares by low price or other criteria and guide selections are sent back to the client by sending a message to the SocketClient object 813. The SocketClient read method which is waiting for this message wakes up to store the received data in a list and goes back to reading more messages 814.

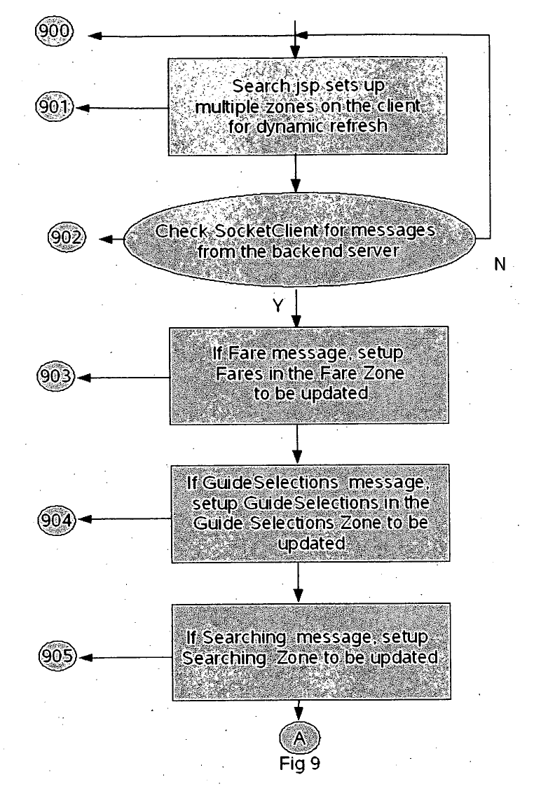

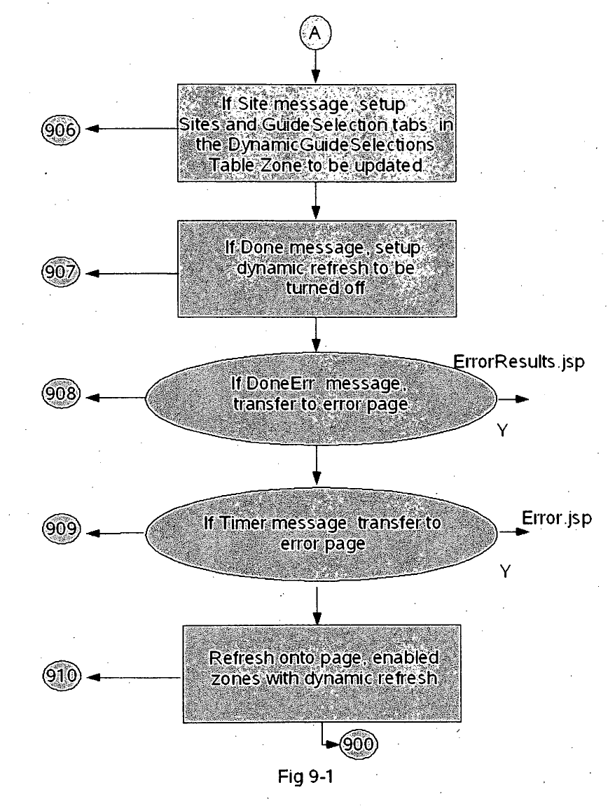

FIG. 9 is a flow chart illustrating the refresh on a client browser. The request which is forwarded to Search.jsp in 704 sets up multiple AjaxAnywhere zones and setups dynamic refresh for the zones at a known interval 901. Next, SocketClient's getLines method is invoked to check for any messages from the backend server 902. If a fare message is available, the fare list is de-serialized to recreate the Fare list and a Fare zone refresh is added 903. If a guideselections message is available, then Guide Selections are de-serialized and a Guide Selection zone refresh is added 904. If booking sites are being searched, a searching message will be available, and a Searching zone refresh is added 905. If a booking site search is completed, a Site message is available with the lowest price and non-stop price and a link to booking site specific results. A site zone refresh is added 906 so that the booking site information can be added to the Dynamic Guide Selections Table as in 405. If the booking sites search is completed, a Done message will be available 907 and this is used to stop the dynamic refresh. The search status is set to done and refresh timer turned off to stop the refreshes. The dynamic refresh is restarted if the user clicks on a navigation link like “prev”, “next”, “page #”, etc. If the user clicks on a “go to” or other “buy links”, the user is transferred to the specific site after a content preview as in FIG. 6. A DoneErr 908 or Timer message 909 will be available if search results in an error or the timer set expires. The timer message indicates that the search did not complete in a known interval, and is used to clean up and end the search. If none of the searches have any valid results, then the user is transferred to an error page. Next, only the zones with information and refresh enabled are rendered onto the page using AjaxAnywhere technology 910.

It should be noted that in the described embodiments, an object oriented programming environment has been described to discuss the present invention. Object Oriented Constructs such as methods, object, attribute, exceptions have been used to describe how the invention works. However, this can also be implemented in other programming environments and languages. It should also be noted that this is an illustration of one of the embodiments. The elements can be retrieved using other methods, and rendered or passed on to other methods or objects, and should not be limited to as shown. Only Booking site and Store view embodiments are discussed and shown here. The invention should not be limited to just these embodiments as other embodiments to retrieve event tickets, consumer products, real estate, automobiles, hotels room prices, vacation packages, cruises, dating, etc. are very easily possible and not discussed here.

While embodiments and applications of this invention have been shown and described, it would be apparent to those skilled in the art having benefit of this disclosure that many more modifications than mentioned above are possible without departing from the inventive concepts herein. The invention, therefore, is not to be restricted except in the spirit of the appended claims.

Definition List 1

| Term | Definition |
|---|---|
| GET | A HTTP method to send/get data from a |
| | server |
| POST | A HTTP method to send/get data from a |
| | server |
| HTTP | A TCP/IP based text request/response |
| | protocol that allows web browsers to show |
| | data from a server called a web server |
| Session | A J2EE HTTP session object, and provides a |
| | way to identify a user across more than one |
| | page request or visit to a Web site and to |
| | store information about that user. |
| J2EE | Java 2 Platform, Enterprise Edition defines |
| | the standard for developing component- |
| | based multi-tier enterprise applications |
| Jsp | JavaServer Pages technology provides a |
| | simplified, fast way to create dynamic web |
| | content |
| URL | Uniform Resource Locator |
| XML | Extensible Markup Language |
| TCP | Transmission Control Protocol |
| IP | Internet Protocol |
| Java | An object oriented programming language |
| MVC | Model View Controller paradigm |
| Web | World wide web, www, also known as the |
| | internet |
| Browser | A Graphical User Interface for viewing |
| | content called html on the web |
| Ajax | A technology to dynamically refresh |
| | content onto a browser client |
| AjaxAnywhere | An open source Ajax implementation |
| | available from |
| | http://ajaxanywhere.sourceforge.net |
| ENeedsOnline | An online marketplace where buyers and |
| | sellers can make available a need, |
| | http://www.eneedsonline.com |

What is claimed is:

1. A method for searching, browsing, collaborating, communicating and buying on the internet or intranet in a computer based system, the method comprising the steps of:
providing a search mechanism with dynamic guiding information and guide selections; said search mechanism with dynamic guiding information with guide selections can be used to buy, compare prices or post a need to a competitive market; said need can be a economic want.

2. A method according to claim 1 wherein said search mechanism is associated with a marketplace; said marketplace offers multiple ways for a user to buy a need; said multiple ways includes searching to find a need, compare, buy or post a need to a competitive process or become knowledgeable about the need; said multiple ways includes a product view with dynamic guiding information and guide selections; said product view allows a user to associate knowledge by comparing prices, guiding information and guide selections; said product view allows the need to be posted to a competitive process or buy immediately or be transferred to another process to make the buy; said multiple ways includes buying from a store view; said store view shows products specific to a store; said store view allows the need to be posted to a competitive process or buy immediately or be transferred to another process to make the buy; said competitive process is a reverse auction allowing the user to make available the need to a plurality of sellers; said guiding information is expert information including demand, lowest, average, highest price and guide selections allowing the user to associate a product with knowledge; said guide selections is a pick of the products; said guide selections are coded with color tabs; said coded tabs allow associating a selection with information; said guide selections allow a user to make input.

3. A method according to claim 1 wherein the search mechanism sends a search request to a server; said server receives the requests, parses the search criteria and sends a message to a backend server; said backend server instantiates the searches using a test suite or a web browser to search different web sites or data sources, validates the results received, waits for any dynamic pages to be refreshed and sends a message back to the server with the search results; said server process with dynamic refresh, receives message, retrieves the results and dynamically updates the results to a user; said dynamic results might be guiding information and guide selections; said results with guiding information and guide selections along with multiple ways to buy allows a user to be knowledgeable and make a buy.

4. A method according to claim 3 wherein said dynamic refresh comprises a plurality of target zones; said target zones could be refreshed selectively; said target zone could include guiding information and guide selections; said target zone might provide multiple ways to buy; said target zone shows results based on a criteria; said target zone shows site specific results; said target zone provides a mechanism to transfer to another site; said target zone provides a mechanism allowing the user to preview content before transferring to another site.

5. A method according to claim 4 wherein said target zone could be a status target zone or a dynamic guide selection table target zone; said target status zone shows status of search; said status includes site name, change in time or percent; said dynamic guide selection table target zone shows guiding information and guide selections and grows dynamically; said guiding information and guide selections allows a user to associate knowledge with a need.

6. A method according to claim 4 wherein a user is transferred to another process, the method comprising the steps: of a user clicking on a transfer link; said click brings up a web page with a dynamic refresh target zones; said target zones includes a status target zone and a content target zone; said status target zone shows a timer; said content target zone shows relevant information or advertisements; said transfer is completed at the end of the timer.

7. A method according to claim 1 wherein said search mechanism is associated with guiding information and guide selections; said guiding information is expert information including demand, lowest, average, highest price and guide selections allowing the user to associate a product with knowledge; said guide selections is a pick of the products; said guide selections are coded with color tabs; said coded tabs allow associating a selection with information; said guide selections allow a user to make input.

8. An apparatus for searching, browsing, collaborating, communicating and buying on the internet or intranet in a computer based system, the apparatus comprising: search mechanism; dynamic guiding information and guide selections; server process; browser; said search mechanism can be used to search for a need; said search request for a need is sent across a network to the said server process; said server process initiates search and sends back relevant results with dynamic guiding information and guide selections to be displayed on the said browser.

9. An apparatus according to claim 8 further comprising: associating the said search mechanism with a marketplace; said marketplace offers multiple ways for a user to buy a need; said multiple ways includes searching to find a need, compare, buy or post a need to a competitive process or become knowledgeable about the need; said multiple ways includes a product view with dynamic guiding information and guide selection; said product view allows a user to associate knowledge by comparing prices, guiding information and guide selection; said product view allows the need to be posted to a competitive process or buy immediately or be transferred to another process to make the buy; said multiple ways includes buying from a store view; said store view shows products specific to a store; said store view allows the need to be posted to a competitive process or buy immediately or be transferred to another process to make the buy; said competitive process is a reverse auction allowing the user to make available the need to a plurality of sellers; said guiding information is an expert information including demand, lowest, average, highest price and guide selections allowing the user to associate a product with knowledge; said guide selections is a pick of the products; said guide selections are coded with color tabs; said coded tabs allow associating a selection with information; said guide selections allow a user to make input.

10. An apparatus according to claim 8 wherein the search mechanism sends a search request to a server process; said server process receives the requests, parses the search criteria and sends a message to another backend server process; said backend server process instantiates the searches using a test suite or a web browser to search different web sites or data sources, validates the results received, waits for any dynamic pages to be refreshed and sends a message back to the server process with the search results; said server process with a dynamic refresh, receives message, retrieves the results and dynamically updates the results to the said browser; said dynamic results might be guiding information and guide selections; said results with guiding information and guide selections along with multiple ways to buy allows a user using the browser to be knowledgeable and make a buy.

11. An apparatus according to claim 10 wherein said dynamic refresh comprises a plurality of target zones; said target zones could be refreshed selectively; said target zone could include guiding information and guide selections; said target zone might provide multiple ways to buy; said target zone shows results based on a criteria; said target zone shows site specific results; said target zone provides a mechanism to transfer to another site; said target zone provides a mechanism allowing the user to preview content before transferring to another site.

12. An apparatus according to claim 11 wherein a user is transferred to another process, the apparatus comprising: user, a transfer link, a server process; said user clicking on said transfer link; said click on said link transfers the request to said server process across a network; said server process sends back a web page with dynamic refresh target zones; said target zones includes a status target zone and a content target zone; said status target zone shows a timer; said content target zone shows pertinent information or advertisements; said transfer is completed at the end of the timer.

13. An apparatus according to claim 8 wherein said search mechanism is associated with guiding information and guide selections; said guiding information is expert information including demand, lowest, average, highest price and guide selections allowing the user to associate a product with knowledge; said guide selections is a pick of the products; said guide selections are coded with color tabs; said coded tabs allow associating a selection with information; said guide selections allow a user to make input.
